(19) United States
(12) Patent Application Publication
(10) Pub. No.: US 2026/0095700 A1
(43) Pub. Date: Apr. 2, 2026

(54) SPEAKER

(71) Applicant: ALPS ALPINE CO., LTD., Tokyo (JP)

(72) Inventor: Tomoki TAKAHATA, Fukushima (JP)

(21) Appl. No.: 19/317,524

(22) Filed: Sep. 3, 2025

(30) Foreign Application Priority Data
Sep. 30, 2024 (JP) 2024-170240

(51) Int. Cl. H04R 9/02; H04R 7/12; H04R 7/18; H04R 9/04; H04R 9/06

(52) U.S. Cl. CPC H04R 9/022; H04R 7/12; H04R 7/18; H04R 9/025; H04R 9/046; H04R 9/06; H04R 2400/11

(57) ABSTRACT

A speaker includes a support that includes a frame and a magnetic circuit fixed rearward of the frame; a diaphragm supported by the frame to be vibratable; a bobbin configured to vibrate along with the diaphragm; and a voice coil provided at the bobbin. The magnetic circuit includes a driving magnet. A magnetic gap is formed between a rear inner yoke and a rear outer yoke that are located rearward of the driving magnet. The voice coil is located in the magnetic gap. The magnetic gap is open to a space rearward of the magnetic circuit.

### CROSS-REFERENCE TO RELATED APPLICATIONS

The present application is based on and claims priority to Japanese Patent Application No. 2024-170240 filed on Sep. 30, 2024, the entire contents of which are hereby incorporated by reference.

### BACKGROUND

### 1. Field of the Invention

The present disclosure relates to a speaker that enables efficient escape of heat generated from a voice coil that is vibrating in a magnetic gap of a magnetic circuit.

### 2. Description of the Related Art

A speaker includes a diaphragm, a bobbin vibrating along with the diaphragm, and a voice coil wound around the bobbin. The voice coil is located in the magnetic gap of a magnetic circuit. The diaphragm is driven by an electromagnetic force generated by a drive current, flowing through the voice coil, and a magnetic field crossing the voice coil. Here, the voice coil generates heat due to Joule heat during vibration. The voice coil includes a bobbin and a conductive wire wound around the bobbin in a plurality of turns, and thus has a relatively large mass. This relatively large mass of the voice coil increases the load of a vibration portion including the diaphragm. The mass of the voice coil can be reduced by reducing the cross-sectional area of the conductive wire forming the voice coil. However, use of a thin conductive wire increases Joule heat, and the conductive wire may be fused during operation of the speaker. Therefore, it is necessary for the magnetic circuit to have a structure that enables the heat generated from the voice coil to escape to the external space.

In the speaker described in Japanese Laid-Open Patent Application Publication No. 1996-9494, a magnet forming a magnetic circuit is provided with a plurality of radially formed through-holes that penetrate through the magnet between the outer circumferential side and the inner circumferential side. Thus, the external air readily flows into the magnetic circuit that is in a semi-sealed state. In the speaker described in Japanese Laid-Open Patent Application Publication No. 2002-262387, the center pole of a magnetic circuit is provided with a through-hole, and the bottom surface of a bottom plate, forming a single part with the center pole, is provided with a groove communicating with the through-hole. This speaker enables air existing in a space enclosed by the bobbin to escape to the exterior from the through-hole through the groove even if the bottom surface of the magnetic circuit is pressed against the inner wall of a housing. In the speaker described in Japanese Laid-open Utility Model Publication No. 1993-9099, the outer circumferential portion of a center pole is provided with a plurality of radially formed slits leading to the upper and lower surfaces, and also the bottom surface of a bowl-shaped yoke is provided with ventilation holes. Formation of the slits and the ventilation holes improves air permeability, and thus prevents an excessive increase in temperature.

### SUMMARY

According to an aspect of the present disclosure, a speaker includes: a support that includes a frame and a magnetic circuit fixed rearward of the frame; a diaphragm supported by the frame to be vibratable; a bobbin configured to vibrate along with the diaphragm; and a voice coil provided at the bobbin. The magnetic circuit includes a driving magnet. A magnetic gap is formed between a rear inner yoke and a rear outer yoke that are located rearward of the driving magnet. The voice coil is located in the magnetic gap. The magnetic gap is open to a space rearward of the magnetic circuit.

In the speaker of the present disclosure, the magnetic circuit may include a magnetic gap formed between a front inner yoke and a front outer yoke that are located forward of the driving magnet. The bobbin may include a voice coil located in the magnetic gap between the front inner yoke and the front outer yoke, and the voice coil located in the magnetic gap between the rear inner yoke and the rear outer yoke.

In the speaker of the present disclosure, preferably, a part of the voice coil may project toward the space rearward of the magnetic circuit from a rear surface of the magnetic circuit at least in a state in which the bobbin is located at a neutral position in a forward and rearward direction, which is a vibration direction.

In the speaker of the present disclosure, the support may include one or more movement holes penetrating in the forward and rearward direction to lead to the magnetic gap. The one or more movement holes may be formed between the diaphragm and the magnetic circuit. A part of the bobbin may vibrate forward and rearward in the one or more movement holes. For example, the one or more movement holes are formed in a yoke forming the magnetic circuit.

In the speaker of the present disclosure, the bobbin may include a plurality of cutouts open to a front end of the bobbin, and a plurality of continuous portions one of which is located between each pair of adjacent cutouts of the plurality of cutouts. The plurality of continuous portions may vibrate forward and rearward in a plurality of the movement holes.

The speaker of the present disclosure preferably includes a reinforcing member configured to connect the plurality of the continuous portions forward of the one or more movement holes. The reinforcing member may be a cap fitted to the front end of the bobbin.

### BRIEF DESCRIPTION OF THE DRAWINGS

FIG. 1 is a perspective view illustrating a speaker of a first embodiment of the present disclosure, and including a vertical cross section of the speaker;

FIG. 2 is a partial exploded perspective view illustrating a bobbin, a voice coil, and a magnetic circuit provided in the speaker illustrated in FIG. 1;

FIG. 3 is a cross-sectional view illustrating the speaker illustrated in FIG. 1 cut along line III-III, specifically, illustrating the magnetic circuit illustrated in FIGS. 1 and 2 as a plane;

FIG. 4 is a partial perspective view illustrating a Modified Example of the present disclosure in which a reinforcing member configured to reinforce the bobbin is provided;

FIG. 5 is a vertical cross-sectional view illustrating a speaker according to a second embodiment of the present disclosure;

FIG. 6 is a partial cross-sectional view illustrating the speaker illustrated in FIG. 4 cut along line VI-VI, specifically, illustrating a movement hole formed in the magnetic circuit of the speaker illustrated in FIG. 5;

FIG. 7A is a chart indicating a simulation result of an Example model of the present disclosure used for demonstrating the effects of the present disclosure;

FIG. 7B is a chart indicating a simulation result of a Comparative Example model used for demonstrating the effects of the present disclosure; and

FIG. 8 is a graph illustrating changes in the average temperature around the voice coils in the Example model illustrated in FIG. 7A and the Comparative Example model illustrated in FIG. 7B.

### DETAILED DESCRIPTION

The speaker described in Japanese Laid-Open Patent Application Publication No. 1996-9494 requires a special magnet including the plurality of radially processed through-holes, which is not suitable in practical use. Also, the bored magnet is reduced in volume, and is also reduced in magnetic force. In both of the speakers described in Japanese Laid-Open Patent Application Publication No. 2002-262387 and Japanese Laid-open Utility Model Publication No. 1993-9099, the magnetic gap, where the voice coil is located, is located forward of the magnetic circuit, and thus the heat generated from the voice coil tends to be retained in the space in the magnetic circuit. Therefore, it is challenging to efficiently discharge the heat to the exterior only through the ventilation hole open in the bottom of the magnetic circuit.

The present disclosure provides a speaker that can cause heat generated from a voice coil in a magnetic gap to efficiently escape to the external space by exposing the magnetic gap to the external space.

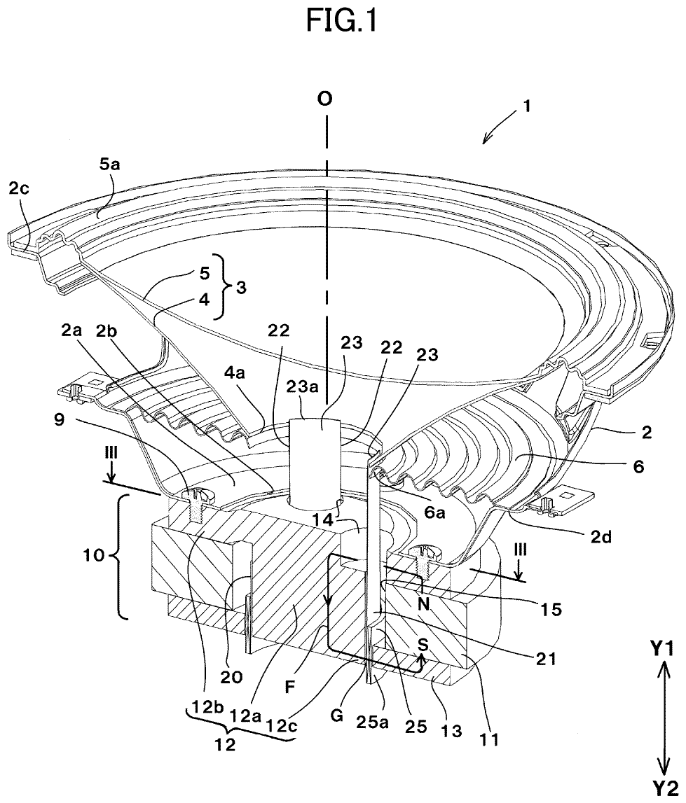

In a speaker 1 according to an embodiment of the present disclosure, a Y1-Y2 direction is the forward and rearward direction, and a Y1 direction is a forward direction (or forward, frontward, or front) and a Y2 direction is a rearward direction (or rearward, backward, or rear). A sound-emitting direction of the speaker 1 is varied with usage of the speaker 1. In some cases, the speaker 1 is used in a state in which the Y1 direction is the sound-emitting direction of the speaker 1. In other cases, the speaker 1 is used in a state in which the Y2 direction is the sound-emitting direction of the speaker 1. FIG. 1 illustrates a center axis O extending in the forward and rearward direction (Y1-Y2 direction). The main parts of the speaker 1 have a substantially rotationally symmetrical structure centered on the center axis O.

The speaker 1 illustrated in FIG. 1 includes a frame 2. The frame 2 is formed of a non-magnetic material or a magnetic material, and has a tapered shape in which the diameter of the frame 2 gradually increases in the forward direction (Y1 direction). The frame 2 includes a rear fixing portion 2a in the rearward direction (Y2 direction), and an opening 2b is formed in the rear fixing portion 2a.

A magnetic circuit 10 is fixed to the rear fixing portion 2a of the frame 2. The magnetic circuit 10 is of an external magnetic type, and includes a ring-shaped driving magnet 11 centered on the center axis O. The magnetic circuit 10 includes a center yoke 12. The center yoke 12 includes a center pole 12a and a front yoke 12b that are integrally formed. The center pole 12a is located inside the driving magnet 11, and the front yoke 12b projects from the front portion of the center pole 12a. A part of the center yoke 12 rearward of the center pole 12a functions as a rear inner yoke 12c. The driving magnet 11 is fixed to the rear surface of the front yoke 12b, and a ring-shaped rear outer yoke 13 is fixed to the rear surface of the driving magnet 11. The center yoke 12 and the rear outer yoke 13 are formed of a magnetic material, i.e., a magnetic metal material. The rear outer yoke 13 is located at the outer circumferential portion of the rear inner yoke 12c, i.e., at a rear portion of the center yoke 12. A magnetic gap G is formed between the outer circumferential surface of the rear inner yoke 12c and the inner circumferential surface of the rear outer yoke 13 along the circumference centered on the center axis O.

The magnetic circuit 10 is disposed at the rear surface of the rear fixing portion 2a of the frame 2. The rear fixing portion 2a and the front yoke 12b of the magnetic circuit 10 are fixed by means of a plurality of fixing screws 9. The frame 2 and the magnetic circuit 10 form a “support”.

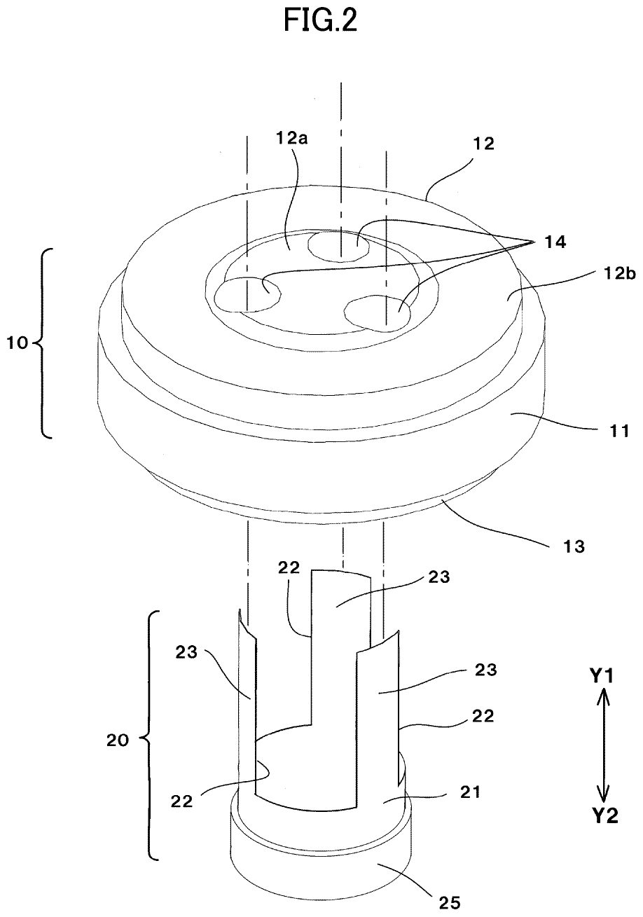

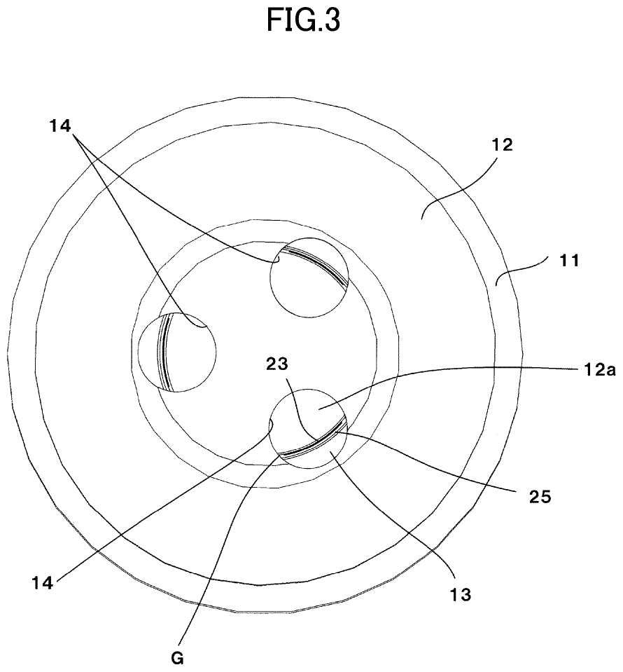

As illustrated in FIGS. 1 and 2, movement holes 14 are formed at a plurality of places at the boundary between the center pole 12a and the front yoke 12b of the center yoke 12. At least a part of each of the movement holes 14 is formed to penetrate through the center yoke 12 forward and rearward. As illustrated in FIG. 3, a part of the center pole 12a, a part of the rear outer yoke 13, and a part of the magnetic gap G are situated within each of the movement holes 14 in a plan view of the magnetic circuit 10. As illustrated in FIG. 1, the inner space of the movement hole 14 communicates with the magnetic gap G through a gap 15 between the outer circumferential surface of the center pole 12a and the inner circumferential surface of the driving magnet 11.

A bobbin 20 is provided at the center of the speaker 1. The bobbin 20 has a cylindrical shape centered on the center axis O. As illustrated in FIG. 2, the bobbin 20 includes a cylindrical portion 21 located rearward (in the Y2 direction), a plurality of cutouts 22 formed to be continuous from forward of the cylindrical portion 21 to the front end of the bobbin 20, and a plurality of continuous portions 23, i.e., portions of the cylindrical portion 21 that remain between the cutouts 22 and 22 next to each other. The plurality of cutouts 22 and the plurality of continuous portions 23 are alternately located in the circumferential direction of the cylindrical portion 21. A voice coil 25 is provided at the rear end of the bobbin 20. The voice coil 25 is formed by winding a conductive wire a plurality of times around the outer circumferential surface of the cylindrical portion 21 of the bobbin 20.

As illustrated in FIG. 2, the bobbin 20 is assembled with the magnetic circuit 10 from rear (Y2 direction) to front (Y1 direction). In this assembling, the continuous portion 23 of the bobbin 20 is inserted from rear into the magnetic gap G of the magnetic circuit 10, and then the continuous portion 23 is inserted into the movement hole 14 through the gap 15 between the outer circumferential surface of the center pole 12a and the inner circumferential surface of the driving magnet 11. As illustrated in FIG. 1, when the bobbin 20 is assembled with the magnetic circuit 10, the front portions of the plurality of continuous portions 23 project forward from the corresponding movement holes 14, the cylindrical portion 21 of the bobbin 20 is located in the gap 15 and the magnetic gap G, and the voice coil 25 is located in the magnetic gap G. The magnetic circuit 10 and the voice coil 25 form a “magnetic driver”.

As illustrated in FIG. 1, a diaphragm 3 is provided inside the front portion of the frame 2. The diaphragm 3 has a two-plate structure in which a rear plate 4 and a front plate 5 are assembled with a front gap and a rear gap. The diaphragm 3 has a cone shape formed by these plates each having a conical shape. An elastically deformable edge member 5a is integrally formed at the outer circumferential edge of the front plate 5 of the diaphragm 3, and the edge member 5a is joined to the front circumferential portion 2c of the frame 2. When the magnetic circuit 10 is fixed to the rear surface of the rear fixing portion 2a of the frame 2 with the plurality of fixing screws 9, the movement hole 14 of the magnetic circuit 10 is situated within the opening 2b of the rear fixing portion 2a. The continuous portion 23 of the bobbin 20 passes through the movement hole 14, and a front end portion 23a is adhesively joined to the inner circumferential surface of a center hole 4a formed in the rear plate 4 of the diaphragm 3. An inner circumferential fixing portion 2d is formed at the inner surface of a middle portion of the frame 2, and the outer circumferential portion of a corrugated elastically deformable damper 6 is adhesively fixed to the inner circumferential fixing portion 2d of the frame 2. An inner circumferential edge 6a of the damper 6 is adhesively fixed to the outer circumferential surface of the continuous portion 23 of the bobbin 20.

The diaphragm 3, the bobbin 20, and the voice coil 25 are supported to be vibratable in the forward and rearward direction (Y1-Y2 direction) relative to the frame 2 (the support) through elastic deformation of the edge member 5a and the damper 6. The diaphragm 3, the bobbin 20, and the voice coil 25 form a “vibration portion”, which is configured to vibrate in the forward and rearward direction (Y1-Y2 direction) relative to the “support” including the frame 2.

Next, an operation for sound emission of the speaker 1 will be described. In the operation for sound emission, a drive current is applied to the voice coil 25 based on an audio signal output from an audio amplifier. In the magnetic circuit 10, a driving magnetic flux F generated from the driving magnet 11 passes through the rear inner yoke 12c from the front yoke 12b, which is a part of the center yoke 12, crosses the magnetic gap G, and reaches the rear outer yoke 13. By the effect of an electromagnetic force excited by the driving magnetic flux F, crossing the voice coil 25 in the magnetic gap G, and the drive current flowing through the voice coil 25, the vibration portion, including the bobbin 20, the voice coil 25, and the diaphragm 3, vibrates in the forward and rearward direction (Y1-Y2 direction). As a result, a sound pressure corresponding to the frequency of the drive current is generated, and a sound is emitted forward or rearward.

When the speaker 1 is operating, Joule heat is generated depending on the intensity of the drive current flowing through the voice coil 25 and the electrical resistance value of the voice coil 25. As a result, the temperature of the voice coil 25 increases, and the temperature inside the magnetic gap G, which is a small space, also increases. Here, the magnetic gap G is open to the external space rearward of the magnetic circuit 10, and the inner space of the magnetic gap G leads directly to the external space rearward of the magnetic circuit 10. This configuration causes heat in the magnetic gap G to readily escape to the external space rearward of the magnetic circuit 10. Also, at least in a state in which the bobbin 20 is located at a neutral position in a vibration direction, i.e., the forward and rearward direction, a rear end 25a of the voice coil 25 projects from the bottom surface of the magnetic circuit 10 to the external space rearward of the magnetic circuit 10. Preferably, the rear end 25a projects from the bottom surface of the magnetic circuit 10 to the external space rearward of the magnetic circuit 10 in the overall range in which the bobbin 20 moves forward and rearward. Therefore, heat of the voice coil 25 can be directly released to the external space. This can suppress an increase in the temperature around the magnetic gap G, and prevent, for example, a phenomenon in which the conductive wire forming the voice coil 25 is fused due to the high temperature.

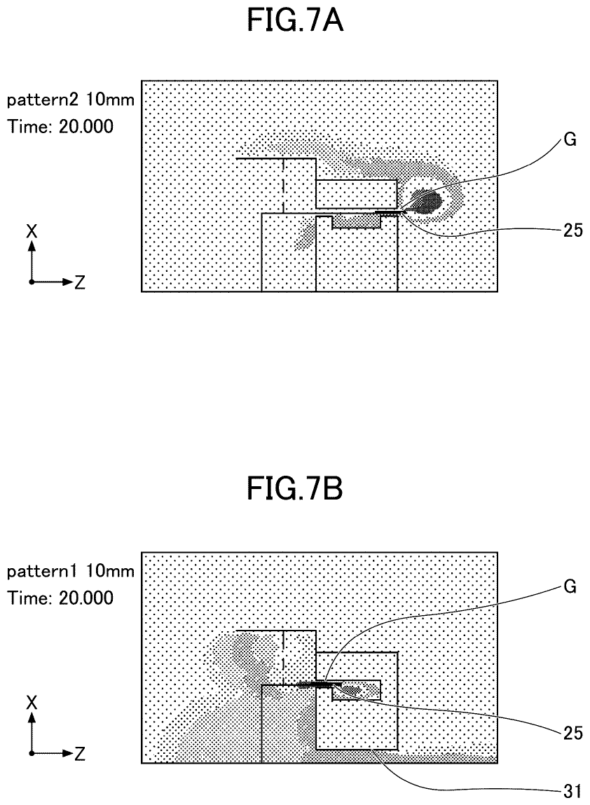

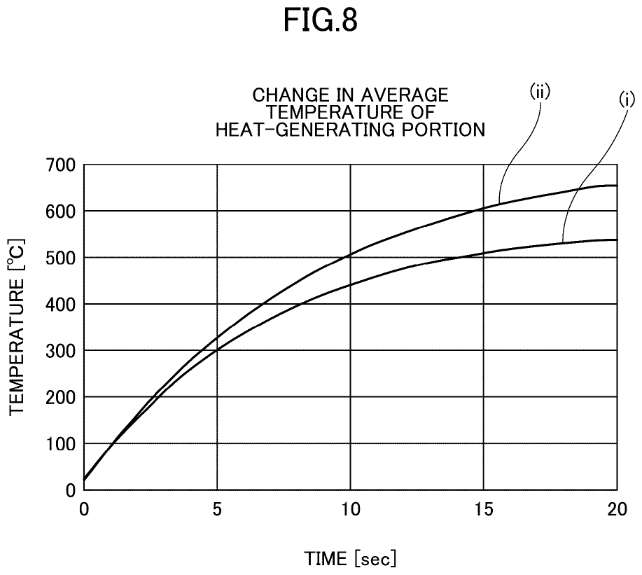

FIGS. 7A and 7B illustrate models used in a simulation for demonstrating the effects of the present disclosure. FIG. 7A is a chart indicating a simulation result of an Example model of the present disclosure. Specifically, in the Example model, the magnetic gap G is directly open to the external space rearward of the magnetic circuit 10, and the voice coil 25 projects rearward of the magnetic circuit 10 at least at the neutral position. FIG. 7B is a chart indicating a simulation result of a Comparative Example model. Specifically, in the Comparative Example model, the center pole is provided with a ventilation hole 31 penetrating through the center pole forward and rearward similar to the publicly known technique described in Japanese Laid-Open Patent Application Publication No. 2002-262387. In both the models, the voice coil is formed of copper, the bobbin is formed of polypropylene (PP), and the yoke including the center pole is formed of iron. For the simulation, the voice coil is set to move by +10 mm from the neutral position at a frequency of 60 Hz in the forward and rearward direction, and the power applied to the voice coil, which is a heat-generating portion, is set to 150 W. In FIGS. 7A and 7B, a region having a higher dot density corresponds to a region having a higher temperature, while a region having a lower dot density corresponds to a region having a lower temperature. In FIG. 8, the vertical axis indicates an average temperature of the heat-generating portion, and the horizontal axis indicates a driving time. In FIG. 8, a curve represented by (i) indicates a change in the temperature of the Example model (pattern 2 of FIG. 7A: {open}), and a curve represented by (ii) indicates a change in the temperature of the Comparative Example model (pattern 1 of FIG. 7B: {normal}). In this simulation, the saturation temperature of the heat-generating portion centered on the voice coil in the Example model is approximately 20% reduced compared to the Comparative Example model.

In the speaker 1 of the present disclosure, the damper 6 is preferably formed of a material substantially not allowing air to pass through. The damper 6 is typically formed of a fiber structure. However, by impregnating the fiber structure with a resin, it is possible to form the fiber structure not allowing air to pass through. Here, the inner space of the bobbin 20 is covered by the front plate 5 located above. Thus, when the damper 6 having a structure substantially not allowing air to pass through vibrates vertically along with the diaphragm 3, the air in a substantially closed space between the damper 6 and the magnetic circuit 10 flows from the movement hole 14 through the gap 15 into the magnetic gap G. As a result, the air in the magnetic gap G is readily discharged to the space rearward of the magnetic circuit 10. The description “substantially not allowing air to pass through” means that, when the damper 6 vibrates forward and rearward at the frequency and amplitude of vibration used in the speaker 1, air does not pass through the damper 6 as a result of a change in the pressure of the air caused by this vibration.

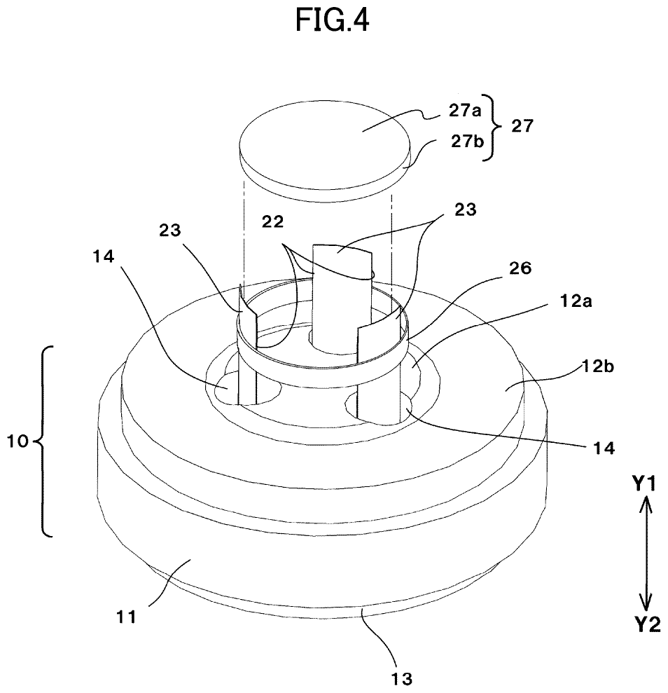

FIG. 4 is a partial perspective view illustrating a Modified Example of the present disclosure. In the structure illustrated in FIG. 4, after the bobbin 20 is assembled with the magnetic circuit 10 from rear to front, the plurality of continuous portions 23 projecting forward of the movement hole 14 of the magnetic circuit 10 are connected to each other by means of a reinforcing member 26, thereby reinforcing the bobbin 20. The reinforcing member 26 is formed, in a ring shape, of a lightweight resin sheet the same as that of the bobbin 20, and is adhered to the outer circumferential surfaces or inner circumferential surfaces of all the continuous portions 23. By providing the reinforcing member 26, it is possible to reinforce the bobbin 20 having the cutouts 22, and suppress distortion of the bobbin 20 due to vibration.

As illustrated in FIG. 4, a cap 27 can be used as a reinforcing member. The cap 27 includes a top plate 27a and a cylindrical circumferential portion 27b, and the circumferential portion 27b is fitted and adhesively fixed to the outer circumferential surfaces of all the continuous portions 23. When the cap 27 is used as a reinforcing member, the relative positions of the adjacent continuous portions 23 become along the cylindrical surface, thereby enabling enhancing the reinforcing effect of the bobbin 20.

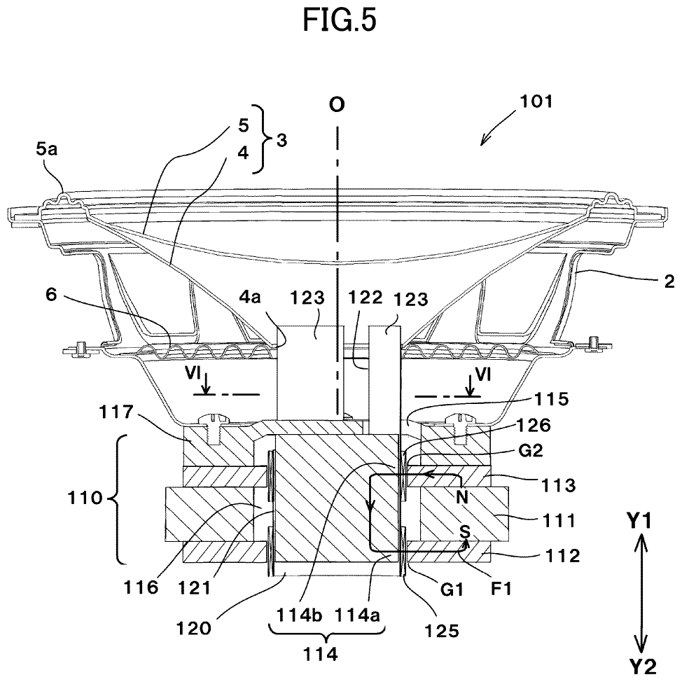

FIG. 5 is a vertical cross-sectional view illustrating a speaker 101 according to a second embodiment of the present disclosure. A magnetic circuit 110 provided in the speaker 101 is of an external magnetic type, and includes a ring-shaped driving magnet 111 located outside a bobbin 120. A ring-shaped rear outer yoke 112 is fixed to the rear surface of the driving magnet 111, and a ring-shaped front outer yoke 113 is fixed to the front surface of the driving magnet 111. A center yoke 114 is provided inside the bobbin 120. The rear outer yoke 112, the front outer yoke 113, and the center yoke 114 are formed of a magnetic material. A rear portion of the center yoke 114 functions as a rear inner yoke 114a, and a rear magnetic gap G1 is formed between the outer circumferential surface of the rear inner yoke 114a and the inner circumferential surface of the rear outer yoke 112. A front portion of the center yoke 114 functions as a front inner yoke 114b, and a front magnetic gap G2 is formed between the outer circumferential surface of the front inner yoke 114b and the inner circumferential surface of the front outer yoke 113.

The front outer yoke 113 and the center yoke 114 are fixed to the rear surface of a magnetic circuit bracket 117, and the magnetic circuit bracket 117 is fixed to the rear fixing portion 2a of the frame 2 by means of the plurality of fixing screws 9. The magnetic circuit bracket 117 is formed of a magnetic material or a non-magnetic material. Movement holes 115 penetrating through the magnetic circuit bracket 117 in the forward and rearward direction are formed at a plurality of places of the magnetic circuit bracket 117. The movement hole 115 communicates with the front magnetic gap G2 and the rear magnetic gap G1 through a gap 116 of the outer circumferential portion of the center yoke 114.

The bobbin 120 includes a cylindrical portion 121, cutouts 122, and continuous portions 123. A rear voice coil 125 and a front voice coil 126 are provided at the outer circumferential surface of the cylindrical portion 121 with a gap in the forward and rearward direction (Y1-Y2 direction). The rear voice coil 125 is formed by a single conductive wire that is wound. The front voice coil 126 is formed by a single conductive wire that is wound in a direction opposite to the direction in which the single conductive wire of the rear voice coil 125 is wound. When the bobbin 120 is assembled with the magnetic circuit 110 from rear, the continuous portions 123 are caused to project forward through the movement holes 115. In the fully assembled state, i.e., in which the front ends of the continuous portions 123 are joined to the center hole 4a of the rear plate 4 of the diaphragm 3, the rear voice coil 125 is located in the rear magnetic gap G1, and the front voice coil 126 is located in the front magnetic gap G2.

In the magnetic circuit 110 illustrated in FIG. 5, a driving magnetic flux F1 generated from the driving magnet 111 crosses the front magnetic gap G2 from the front outer yoke 113, crosses the rear magnetic gap G1 from the center yoke 114, and returns to the driving magnet 111 through the rear outer yoke 112. Both the front voice coil 126 in the front magnetic gap G2 and the rear voice coil 125 in the rear magnetic gap G1 exhibit driving forces symmetrical in the forward and rearward direction. This enables vibration while maintaining linearity in the forward and rearward direction of the vibration portion. In the speaker 101 illustrated in FIG. 5, the rear magnetic gap G1 is open to the external space rearward of the magnetic circuit 110, and a part of the rear voice coil 125 projects toward the external space rearward of the magnetic circuit 110. This configuration facilitates escape of heat of the rear voice coil 125. Also, the front magnetic gap G2 and the front voice coil 126 are also close to the external space rearward of the magnetic circuit 110, and this configuration facilitates rearward escape of heat of the front voice coil 126.

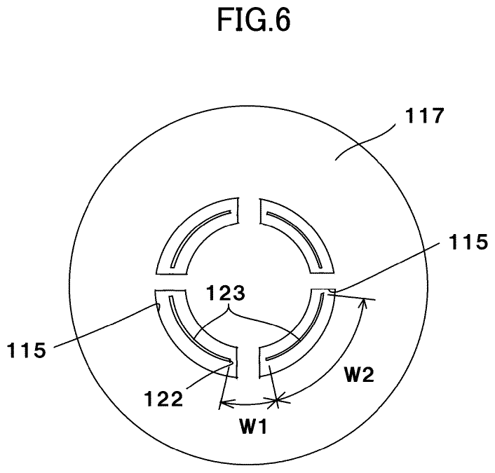

In the magnetic circuit 110 illustrated in FIG. 5, the driving magnetic flux F1 generated from the driving magnet 111 forms a circuit path primarily through the front outer yoke 113, the center yoke 114, and the rear outer yoke 112. Also, the movement holes 115 formed in the magnetic circuit bracket 117 are not located on the circuit path of the driving magnetic flux F1, and thus the movement holes 115 do not act as magnetic reluctance against the driving magnetic flux F1. Therefore, as illustrated in FIG. 6, even if the movement holes 115 formed in the magnetic circuit bracket 117 are opened to be long in the circumferential direction, driving of the vibration portion is not affected. Therefore, as illustrated in FIG. 6, the bobbin 120 can reduce a circumferential width W1 of the cutout 122, and increase a circumferential width W2 of the continuous portion 123. Therefore, the bobbin 120 can maintain a high degree of strength even if the bobbin 120 has the cutouts 122.

In the second embodiment illustrated in FIG. 5, the magnetic circuit bracket 117 is not provided, and the front outer yoke 113 and the center yoke 114 may be directly fixed to the rear fixing portion 2a of the frame 2 by means of the plurality of fixing screws 9. In this case, movement holes through which the continuous portions 123 of the bobbin 120 pass are formed in the rear fixing portion 2a of the frame 2.

Although the magnetic circuit 10 illustrated in FIG. 1 and the magnetic circuit 110 illustrated in FIG. 5 are of an external magnetic type in which the driving magnet is provided on the outer circumferential side of the bobbin, these magnetic circuits can be configured to be of an internal magnetic type. That is, in the magnetic circuit 10 illustrated in FIG. 1, the disk-shaped driving magnet and the rear inner yoke may be disposed inside the bobbin 20. In the magnetic circuit 110 illustrated in FIG. 5, the disk-shaped driving magnet, the rear inner yoke, and the front inner yoke may be disposed inside the bobbin 120.

In the speaker of the present disclosure, a magnetic gap is formed between the rear inner yoke and the rear outer yoke that are located rearward of the driving magnet in the magnetic circuit, and the magnetic gap is open to a rear space. Preferably, in a state in which the bobbin is located at the neutral position in the vibration direction that is the forward and rearward direction, a part of the voice coil projects toward the rear space from the rear surface of the magnetic circuit. Therefore, it is possible to cause heat generated from the voice coil to efficiently escape to the rear space, and readily prevent an increase in the temperature of the voice coil and the periphery of the voice coil.

What is claimed is:

1. A speaker, comprising:
a support that includes a frame and a magnetic circuit fixed rearward of the frame;
a diaphragm supported by the frame to be vibratable;
a bobbin configured to vibrate along with the diaphragm; and
a voice coil provided at the bobbin, wherein
the magnetic circuit includes a driving magnet,
a magnetic gap is formed between a rear inner yoke and a rear outer yoke that are located rearward of the driving magnet,
the voice coil is located in the magnetic gap, and
the magnetic gap is open to a space rearward of the magnetic circuit.

2. The speaker according to claim 1, wherein
the magnetic circuit includes a magnetic gap formed between a front inner yoke and a front outer yoke that are located forward of the driving magnet, and
the bobbin includes
a voice coil located in the magnetic gap between the front inner yoke and the front outer yoke, and
the voice coil located in the magnetic gap between the rear inner yoke and the rear outer yoke.

3. The speaker according to claim 1, wherein
a part of the voice coil projects toward the space rearward of the magnetic circuit from a rear surface of the magnetic circuit at least in a state in which the bobbin is located at a neutral position in a forward and rearward direction, which is a vibration direction.

4. The speaker according to claim 1, wherein
the support includes one or more movement holes penetrating in a forward and rearward direction to lead to the magnetic gap,
the one or more movement holes are formed between the diaphragm and the magnetic circuit, and
a part of the bobbin vibrates forward and rearward in the one or more movement holes.

5. The speaker according to claim 4, wherein
the one or more movement holes are formed in a yoke forming the magnetic circuit.

6. The speaker according to claim 4, wherein
the bobbin includes
a plurality of cutouts open to a front end of the bobbin, and
a plurality of continuous portions one of which is located between each pair of adjacent cutouts of the plurality of cutouts, and
the plurality of continuous portions vibrate forward and rearward in a plurality of the movement holes.

7. The speaker according to claim 6, further comprising:
a reinforcing member configured to connect the plurality of the continuous portions forward of the one or more movement holes.

8. The speaker according to claim 7, wherein
the reinforcing member is a cap fitted to the front end of the bobbin.
